(19) United States
(12) Patent Application Publication
(10) Pub. No.: US 2022/0228993 A1
(43) Pub. Date: Jul. 21, 2022

(54) ADSORBABLE POLYMERIC SURFACE-ENHANCED RAMAN SPECTROSCOPY SUBSTRATES AND THE FABRICATION PROCESS

(71) Applicant: NATIONAL SCIENCE AND TECHNOLOGY DEVELOPMENT AGENCY, Pathumthani (TH)

(72) Inventors: Pitak EIAMCHAI, Pathumthani (TH); Noppadon NUNTAWONG, Pathumthani (TH); Mati HORPRATHUM, Pathumthani (TH); Saksorn LIMWICHEAN, Pathumthani (TH); Nutthamon LIMSUWAN, Pathumthani (TH); Viyapol PATTHANASETTAKUL, Pathumthani (TH); Chanunthorn CHANANONNAWATHORN, Pathumthani (TH); Sukon KALASUNG, Chumphon (TH); Pacharamon SOMBOONSAKSRI, Saraburi (TH)

(73) Assignee: NATIONAL SCIENCE AND TECHNOLOGY DEVELOPMENT AGENCY, Pathumthani (TH)

(21) Appl. No.: 17/614,068

(22) PCT Filed: May 29, 2020
(86) PCT No.: PCT/TH2020/000034

§ 371 Date: Nov. 24, 2021

(30) Foreign Application Priority Data
May 31, 2019 (TH) 1901003276

(51) Int. Cl. G01N 21/65

(52) U.S. Cl. CPC G01N 21/658; G01N 2201/0612

(57) ABSTRACT

The present invention related to surface-enhanced Raman spectroscopy (SERS) substrates that are adsorbable and flexible comprises a polymeric base with detailed specific embossed structures on the surface and noble metal nanoparticles coated on the polymeric base, wherein the capillary effect is exhibited by the nanometer-sized rough features embedded in the micrometer-sized stripe patterns on the surface of the embossed polymeric base, the distances between the coated noble metal nanoparticles are between 50-200 nm to allow for sufficient number of hot spots for high Raman signal enhancement, the ridge width of the embossed stripe pattern is between 15-80 pm, and the distance between the ridges of the embossed stripe pattern is 0.04-0.14 mm.

### FIELD OF THE INVENTION

The present invention relates to thin film technology, Raman spectroscopy, material science, laser engraving technique and metal deposition by sputtering technique.

### BACKGROUND OF THE INVENTION

The analysis of Raman spectra is able to identify specific properties of any biochemical substances and biomolecules. This is due to the fact that each substance has a specific amount of inelastic photon scattering (Raman scattering). As a result, each substance has a distinctive Raman spectrum. Therefore, the analysis of Raman spectra is a suitable technique to use as biosensors, which are sensors for the detection of bio-chemical substances and biomolecules. For example, if Raman spectra of an illicit drug can be obtained, then we can determine exactly the name of the drug. The same principle also works for other substances such as germs and toxic residuals.

Nevertheless, the signals of Raman scattering from biochemical substances and biomolecules are usually weak, which make the analysis difficult. In 1974, Fleischmann, et. al. discovered that rough silver sheet when used as a substrate for the substance in question while the laser light is shone upon, is able to magnify the Raman signal by 6 times. (M. Fleischmann, P. J. Hendra, A. J. McQuilan, Chem. Phys. Lett. 26, 163-166 (1974) and M. J. Weaver, S. Farquharson, and M. A. Tadayyoni, J. Chem. Phys. 82, 4867 (1985)) Surface enhanced Raman scattering is when photons from laser light are directed at the cloud of free electrons surrounding the surface of the metal substrate and the substance on that substrate. By doing so, the cloud of free electrons is stimulated by the photons and this phenomenon is referred to as having the surface plasmons where particle scattering results in different energy level. The resultant energy level is the Raman signal of the substance on the metal substrate. (M. J. Weaver, S. Farquharson, and M. A. Tadayyoni, J. Chem. Phys. 82, 4867 (1985) and B. Pettinger, J. Chem. Phys. 85, 7442 (1986))

As the previous literature suggested, it is understood that the enhancement of Raman signal can be accomplished by two mechanisms. The first one is by the stimulation of the surface plasmons which magnifies the electromagnetic fields surrounding the substance and yields the enhanced Raman signal. The second mechanism is the chemical adsorption of the molecules of the substance on the substrate. (A. Campion, P. Kambhampai, Chem. Soc. Rev. 27, 241 (1998) and M. Moskovits, Rev. Mod. Phys. 57, 783 (1985)) From these two mechanisms in which Raman signals can be enhanced, numerous studies have then been performed to find the substrates and processes which will produce the highest signal enhancement. As for the first mechanism, it has been shown in the literature that when using roughened noble metal sheets such as gold, silver and copper, as the substrates, the signal is magnified greatly. This is due the fact that there are a lot of free electron clouds on the surface of noble metals. So this type of substrate, the roughened noble metal surface, has been applied to use for the detection of a single molecule since the Raman signal enhancement can be as high as 10⁶ to 10¹¹ times. Because of this, using the substrate of the roughened noble metal surface has been used for the detection of various biomolecules and chemical-molecules. (S. Nie, S. R. Emory, Science 275, 1102 (1997)) The development of the process to make SERS substrates has been an ongoing research topic and various types of roughened surface structures have been investigated. These structures include nanorods, nanoclusters and nanoparticles. The nanoclusters are created by electron-beam lithography which is a costly and timely technique. (U. Huebner, K. Weber a, D. Cialla, R. Haehle, H. Schneidewinda, M. Zeisberger, R. Mattheis, H.-G. Meyer, J. Popp, Microelectronic Engineering 98, 444-447 (2012)) On the other hand, the nanoparticles are created by an electrochemical process to prepare silver colloids which are shown to have high Raman signal enhancement. (T. M. Cotton, S. G. Schultz, R. P. Vanduyne, J. Am. Chem. Soc. 102, 7960 (1980), Y. W. C. Cao, R. C. Jin, C. A. Mirkin, Science 297, 1536 (2002), J. Jiang, K. Bosnick, M. Maillard, L. Brus, J. Phys. Chem. B 107, 9964 (2003), and B. D. Moore, L. Stevenson, A. Watt, S. Flitsch, N. J. Turner, C. Cassidy, D. Graham, Nat. Biotechnol. 22, 1133 (2004)) Nevertheless, the nanoparticle-type substrates face the problems where the nanoparticles prepared by a chemical reduction process typically are covered by organic compounds that interfere with Raman spectra. To overcome this problem, silver nanorods fabricated by physical vapor deposition (PVD) have shown to work well and quite easily when Raman spectral analysis is performed. Plus, they give a great Raman signal enhancement. Moreover, the PVD is a well-known process in which the parameters involved are well understood. Therefore, the substrates fabricated from this method are of high quality, uniform and repeatable. Though there is a drawback, which is the short shelf-life of only 29 days for detecting methylene blue (MB) of concentration 10⁻⁶ Mol. (N. Nuntawong, P. Eiamchai, B. Wong-ek, M. Horprathum, K. Limwichean, V. Patthanasettakul, P. Chindaudom, Vacuum 88, 23-27 (2013))

Currently, the research trend regarding SERS technique is focusing on increasing the enhancement of the Raman signal while reducing the manufacturing costs of SERS substrates. Apparently, these two attributes can be achieved by fabricating SERS substrates which have a nanometer-sized roughness existing in a micrometer-sized roughness for the surface structure from the chemical vapor deposition technique (CVD), and then depositing a noble metal on the rough structures by the physical vapor deposition technique (PVD). (G. Sinha, L. E. Depero, I. Alessandri, ACS Appl. Mater. Interfaces 3, 7, 2557-2563 (2011)) The CVD combined with PVD techniques yield SERS substrates that have higher signal enhancement while using lesser amount of noble metal which reduces the manufacturing cost. The resulting structure of this type of SERS substrate is referred to as the “Hybrid SERS” or “3D SERS.” The underlying principle that attributes to the increasing enhancement is in that the nanometer-in-micrometer roughness of the substrates causes the nanoparticles of the substance in question to give out surface plasmon resonance (SPR) when stimulated by photons in laser light. The positions in SPR that have the highest electromagnetic field are referred to as “hot spots” where scattering of light becomes greater. Therefore, greater Raman signal enhancement is achieved through having various hot spots on SERS substrates. The higher there are the numbers of hot spots on the substrate, the greater there is the signal enhancement. This phenomenon was studied and presented by Ruobing Han, et al., where they showed that hot spots can be formed in various positions. For their reusable 3D SERS substrates, hot spots were found at the very top and on the sides of each roughened nano-structures. (X. He, H. Wang, Q. Zhang, Z. Li, X. Wang, Journal of Inorganic Chemistry 14, 2431 (2014))

### SUMMARY OF THE INVENTION

The invention in this application, adsorbable polymeric surface-enhanced Raman spectroscopy (SERS) substrates and the fabrication process, presents innovative SERS substrates that are flexible and equipped with nano-in-micro rough structures (nanometer-sized roughness existing in a micrometer-sized roughness) on the surface. The process presented is straightforward, low cost and not time-consuming. Yet, it yields sophisticated SERS substrates that are flexible, adsorbable and highly sensitive. Furthermore, the SERS substrates from this process may not require complicated sample preparation of the substance in question when Raman spectroscopy is performed. With the majority of current SERS substrates in the market, sample preparation of the substance in question is required. But with these SER substrates, they can be rubbed or smeared on the sample. This is due to the capillary effect which is the attribution from the nano-in-micro rough structures of a polymeric material. Through the capillary effect, the SER substrates will adsorb particles from the sample. Then the substrates can be put into a Raman spectroscope to read the result right away. No sample preparation such as dilution in a solution and leave it to dry on the substrates are necessary. Also, there is no need to extract any particle from the sample in question since with these SERS substrates they can simply be smeared on the sample. Hence, it is considered a non-destructive method which is a great benefit.

One aspect of the invention, the material used to make these flexible SERS substrates is polydimethylsiloxane (PDMS) and with the nano-in-micro roughness, these substrates are able to adsorb the detecting substance onto their surface. The nano-in-micro rough features of the mold used to repeatably produce PDMS substrates is created by laser engraving from a laser marking machine. The optimized condition on the laser marking machine to give precise nano-in-micro rough features on the PDMS substrate surface is presented in this patent application. This includes laser power of 10-20 Watts, laser fill spacing of 0.04-0.14 mm, laser marking speed of 300-700 mm/s, laser frequency of 20-50 kHz and laser passes of 1-10 times. Following the given setting of parameters, PDMS substrates with embossed patterns of nano-in-micro-scale surface roughness are achieved. Then nanoparticles of noble metal are coated on the PDMS substrates in the physical vapor deposition system for 10-300 seconds. Once nanoparticles of noble metal are coated on top with separation distance between one another of 50-200 nm, hot spots will take place when stimulated by laser light and the results are the active and working SERS substrates. In testing the performance of these PDMS SERS substrates, it was found that MB concentration as low as 1×10⁻⁶ Mol could be detected. Furthermore, these substrates are able to perform non-destructive detection of pen ink written on a piece of paper by simply rubbing a PDMS SERS substrate on the paper. The ink particles on the paper are then adsorbed onto the PDMS SERS substrate which can be placed in the Raman spectroscope to analyze right away. Therefore, the invention presented in this patent application yields high performance SERS substrates that can adsorb detecting particles which in many cases make the sample preparation easy and non-destructive.

### BRIEF DESCRIPTION OF THE DRAWINGS

FIG. 1: Fabrication process of adsorbable polymeric surface-enhanced Raman spectroscopy (SERS) substrates comprising (1) making a metal mold by using a laser marking machine to create roughness on a metal sheet (2) the mold is achieved after nano-in-micro rough structures are engraved on the surface of the metal sheet using the optimized parameters on the laser marking machine (3) the pre-polymer mixture is poured onto the metal mold and then cured (4) releasing the polymeric substrates from the mold to achieve the flexible PDMS substrates with surface features of the nano-in-micro rough structures (5) nanoparticles of noble metal are coated on the surface of the PDMS substrates in a physical vapor deposition system (6) the finished product of adsorbable polymeric SERS substrate with nano-in-micro rough structures on the surface plus abundant numbers of hot spots to enhance the signal

FIG. 2: (a) Surface of the metal molds after being roughened by a laser marking machine with the fill spacing of 0.02-0.14 mm; (b) surface of polymeric substrates that have been cured and released from the mold that has fill spacing of 0.02-0.14 mm; (c) surface of the finished product after nanoparticles of noble metal is coated onto the polymeric substrates which are released from that mold that has fill spacing of 0.02-0.14 mm

FIG. 3: Microscopic images of (1) surface of metal mold fabricated based on the setting on the laser marking machine of 0.02-0.14 mm fill spacing; (2) surface of PDMS substrates created from a metal mold which was fabricated with 0.02-0.14 mm fill spacing; (3) surface of polymeric SERS substrate that has noble metal nanoparticles coated on top and the substrate was created from a metal mold based on 0.02-0.14 mm fill spacing setting on the laser marking machine

FIG. 4: Scanning electron microscope (SEM) images showing physical topography from top view and cross-sectional view of (a) the mold made from roughening the metal sheet surface by a laser marking machine (b) the polymeric SERS substrate based on the mold in image (4.a) and with noble metal nanoparticles coated on top

FIG. 5: Raman spectrum when MB of concentration 1.0×10⁻⁶ Mol was dropped on (a) PDMS surface that is flat; (b) PDMS surface made from a mold that was created by a laser marking machine with spacing of 0.02 mm; and (c) PDMS surface made from a mold that was created by a laser marking machine with spacing of 0.04-0.14 mm

FIG. 6: Raman spectrum when MB of concentration 1.0×10⁻⁶ Mol was dropped on (a) PDMS surface made from a mold that was created by a laser marking machine with spacing of 0.02 mm and (b) PDMS surface made from a mold that was created by a laser marking machine with spacing of 0.04-0.14 mm

FIG. 7: Raman spectrum from a polymeric SERS substrate that was fabricated from a mold that was laser engraved by the setting of 0.04-0.14 mm fill spacing and when used to test 1.0×10⁻⁶ Mol of MB with varying type of dissolving solution including (a) chloroform mixed with methanol (b) methanol (c) chloroform (d) isopropyl alcohol (e) acetone and (f) no solution (measured without any dissolving solution)

FIG. 8: Raman spectrum from a polymeric SERS substrate when used to detect pen ink written on a paper (a) showing the Raman spectrum of the polymeric SERS substrate before testing, (b) showing the Raman spectrum of pen ink written on a paper without using the polymeric SERS substrate, (c) showing the Raman spectrum when using the polymeric SERS substrate to detect the pen ink written on a piece of paper by smearing the SERS substrate on top of the paper, (d) physical image of an adsorbable polymeric SERS substrate prior to being used to perform any test, (e) image of the piece of paper and pen ink written on it that was used in this study with the red circle indicating the area where the polymeric SERS substrate was smeared on, (f) microscopic image of the red circled area prior to smearing, and (g) microscopic image of the red circled area post smearing

### DESCRIPTION OF THE PREFERRED EMBODIMENTS

The present disclosure provides for adsorbable and flexible SERS substrates that are made of polymeric material and its fabrication process. To develop SERS substrates that can perform non-invasive and non-destructive measurements to the samples in question while still provide fast and accurate results, flexible and adsorbable substrates are realized.

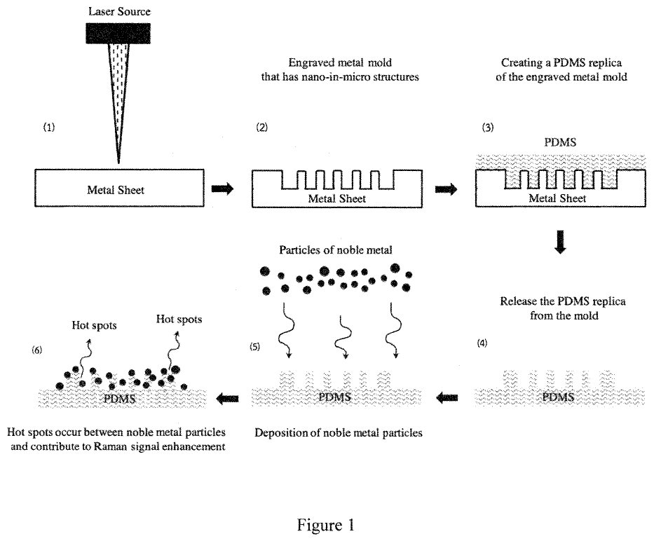

The adsorbable polymeric SERS substrate presented in this invention, as shown in FIG. 1(6), comprises a flexible and adsorbable substrate with noble metal nanoparticles coated on top.

The Flexible and Adsorbable Substrate
The flexibility of the substrate results from the choice of polymeric material which can be chosen from any one of PDMS, PMMA or epoxy-based negative photoresist (such as SU-8). The attribute which makes the substrate adsorbable comes from the texturized roughness on the substrate's surface. There are micro-sized strip patterns embossed on the surface of the polymeric substrate. The width of each embossed strip is between 15-80 μm and the distance between adjacent embossed strips is 0.04-0.14 mm apart. Plus, within the embossed strips there also exist the nano-sized roughness. In other words, the surface of the polymeric substrate contains nano-in-micro features of texturized roughness. As a result of the nano-in-micro texturized features of the substrate's surface, the substrate possesses the capillary effect.

The Coated Noble Metal Nanoparticles
In a particular embodiment, a noble metal is selected from the group comprising silver (Ag), gold (Au), platinum (Pt), copper (Cu) and palladium (Pd). The noble metal nanoparticles are coated in such a way that the particles are between 50-200 nm apart.

Furthermore, the present disclosure provides for the fabrication process of the adsorbable polymeric SERS substrates.

The Preparation of the Metal Mold
This section describes the process methods associated using a metal mold with laser-engraved nano-in-micro rough features on the surface. Metal sheets that do not absorb laser light are suitable to be used as a mold that is prepared by a laser marking machine, which is an Nd-YAG laser with laser wavelength between 1,000-1,100 nm. In an exemplary embodiment, choices of metals for making the mold by the laser engraving technique include, but are not limited to, aluminium (Al), copper (Cu), cobalt (Co), molybdenum (Mo), nickel (Ni), stainless steel, and zinc (Zn). In a particular exemplary embodiment, the nano-in-micro rough structures of the metal mold is controlled by the following laser parameters and their plausible ranges as follows:
laser power between 1-20 W,
laser fill spacing between 0.02-0.14 mm,
laser marking speed between 1-10,000 mm/s,
laser frequency between 30-300 kHz, and
laser passes of 1-50 times.

The Creation of Polymeric Replicas
This section explains the process methods in which the mold from the previous section is used to make polymeric replicas. The polymeric replicas serve as being flexible, and when fabricated from the mold that has the optimized rough structures, they are also adsorbable. In a particular embodiment, the PDMS is chosen as the material for the polymeric substrate. The PDMS is supplied in two components, a base and a curing agent which are mixed together. Pouring the liquid mixture onto the mold and it then conforms to the shape of the mold. Releasing the replicas from the mold yields free-standing polymeric substrates.

The Coating of Noble Metal Nanoparticles
Since a high volume of electron clouds of noble metals contributes to having a greater amount of hot spot, nanoparticles of a noble metal are deposited on the free-standing polymeric substrate to form a working SERS substrate that is flexible and adsorbable. In a particular embodiment, a noble metal is selected from the group comprising silver (Ag), gold (Au), platinum (Pt), copper (Cu) and palladium (Pd). Particles of noble metal can be deposited in the nanometer range onto the polymeric substrate by a physical vapor deposition system (PVD). In an exemplary embodiment, the common range of parameters for noble metal deposition by a PVD comprises:
   pre-deposited chamber pressure of 5×10⁻⁶ mbar,
   argon flow rate during deposition of 5-15 cm⁻³/min,
   chamber pressure during deposition regulated between 9×10⁻³-9×10⁻² mbar,
   DC current of the sputtering system between 0.1-0.5 A,
   power of 50-200 W, and
   time of deposition between 1-400 s.

The present disclosure is described in details with reference to the following embodiments by ways of examples:

### Example I

The process flow from start to finish of a ready-to-use polymeric SERS substrate is depicted in FIG. 1. The numeric labels in FIG. 1 entail each step in the entire process starting from:
(1) preparing a metal sheet to be used as a mold and setting a laser marking machine to engrave the metal sheet,
(2) creating nano-in-micro rough structures on the metal sheet by laser engraving,
(3) using the laser-engraved metal sheet as a mold to create a PDMS replica,
(4) releasing the PDMS replica from the metal mold to have the polymeric substrate with nano-in-micro rough structures embossed on the surface,
(5) depositing nanoparticles of noble metal onto the PDMS replica,
(6) the finished product of the adsorbable polymeric SERS substrate, which offers a high number of hot spots as a result of noble metal nanoparticles deposited on the nano-in-micro rough structures of the PDMS replica.

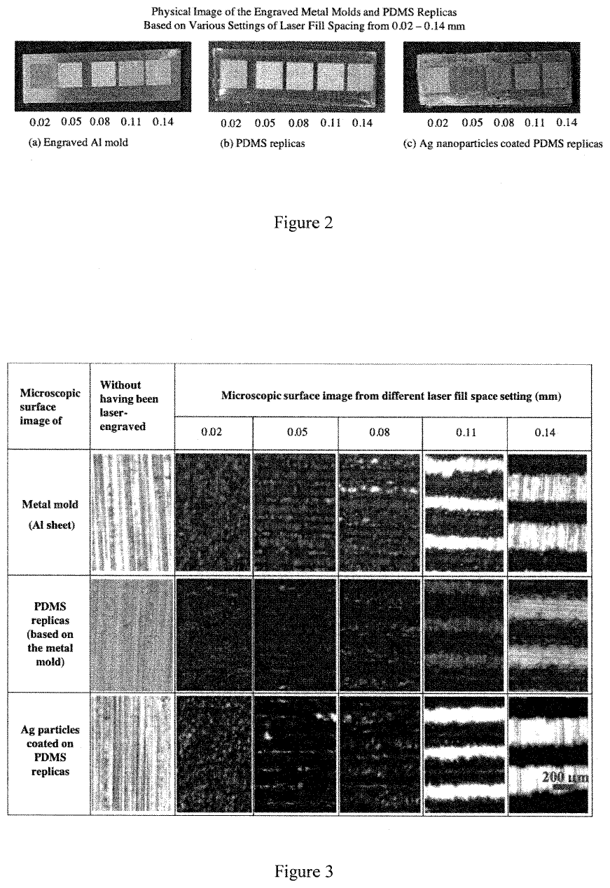

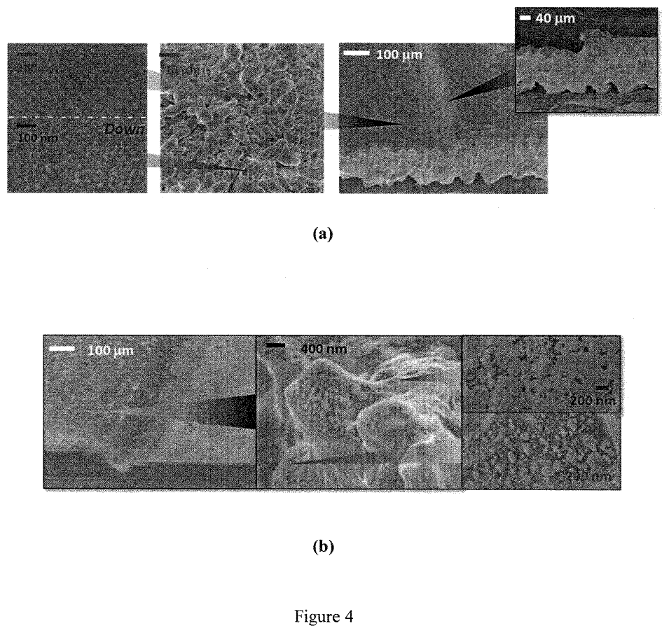

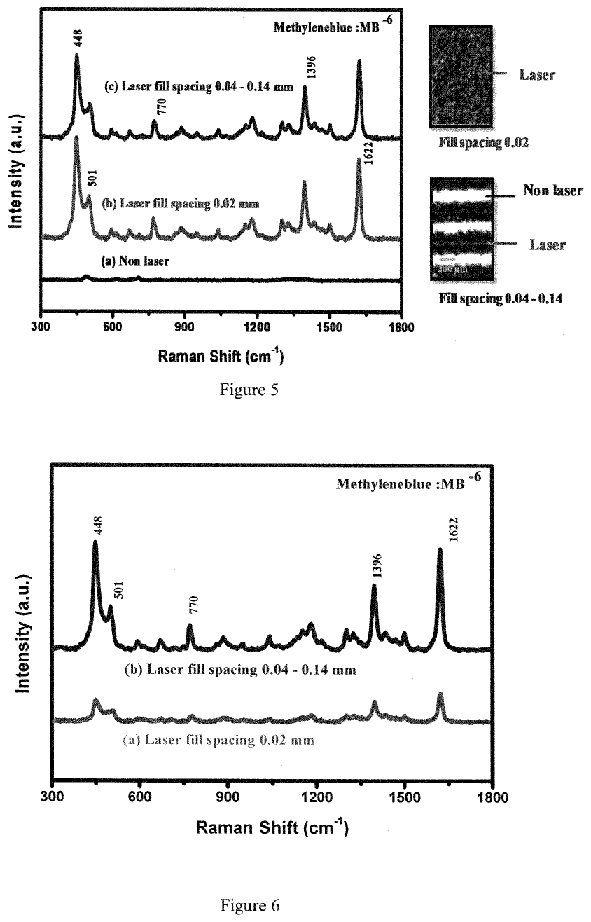

In a particular embodiment, the metal sheet to be used as a mold is selected to be 0.4 mm thick aluminium (Al) sheet. Aluminium does not absorb laser light and is vastly obtainable in the market. A 3-step sonication in acetone, isopropanol and deionized (DI) water for 10 minutes each is employed to clean the Al sheet. Then it is dried up by a nitrogen gun. In a particular exemplary embodiment, a programmable laser marking machine is used to engrave nano-in-micro rough structures on the Al sheet to make the mold. The engraved area is designed to encompass the area of 5×5 mm². In a particular exemplary embodiment, the rough texture of the metal mold which will be the pattern of the surface of a PDMS substrate is required to give the capillary effect to the PDMS substrate. For the PDMS substrate to have the capillary effect, particles from the substance in question must be able to adsorb to the substrate. In a particular exemplary embodiment, the roughness of the metal mold that will yield the capillary effect to the PDMS substrate is determined by the following parameters: laser power between 1-20 W, laser fill spacing between 0.02-0.14 mm, laser marking speed between 1-10,000 mm/s, laser frequency between 30-300 kHz, laser passes of 1-50 times. The laser fill spacing parameter is the key that determines whether the PDMS substrate will have the capillary effect as depicted in FIG. 2 and FIG. 3. In FIG. 2, physical top-down images of the Al sheet are shown in (a) for different condition of laser fill spacing from 0.02-0.14 mm. Similarly, for different laser spacing setting, physical top-down images of the PDMS replicas are shown in (b), and physical top-down images of the final polymeric SERS substrates with Ag nanoparticles coated on top are shown in (c). Furthermore, FIG. 3 depicts optical microscopic images of the surface of the Al mold, the PDMS replicas and the polymeric SERS substrate with Ag coated on top for different value of laser fill spacing. As shown in FIG. 3, the parts of the surface that are laser engraved are shown in darker color (black stripes), while the parts that are not laser engraved appear in lighter color (white stripes). As the laser fill spacing setting increases from 0.02 mm to 0.14 mm, the black and white patterns spread out and become less dense. In fact, when the laser fill spacing is set at 0.02 mm, the image shows that the entire area has been engraved and the black and white patterns disappear. In a particular embodiment, the laser fill spacing settings of 0.04-0.14 mm result in the black and white stripe patterns in such a way that the non-engraved areas (white stripes) have the width of 15-80 μm, respectively. Further analysis by the field-emission scanning electron microscope (FE-SEM) depicted in FIG. 4(a) exemplifies that the size of the areas that have been engraved (black stripes) are in micron and within them are smaller rough features of nanometer size. Having the rough structures of the size in nanometer range embedded in the engraved areas of the micron-sized engraved and non-engraved patterns as shown in FIG. 4(b), give the polymeric SERS substrates the capillary effect.

### Example II

In a further exemplary embodiment, the polymeric SERS substrates are achieved by fabricating PDMS replicas from the Al mold that was prepared by a laser marking machine. The PDMS used in this invention is supplied in two components, a base and a curing agent. To produce a replica, the base and curing agent are mixed together between 10:1 to 10:5 ratio (10 parts base for 1 part or 5 parts curing agent). The liquid mixture is brought into the desiccator for 90 minutes to eliminate air bubbles. Then the mixture (pre-polymer) is poured over the metal mold that was prepared by the laser marking machine and brought back inside the desiccator for another 90 minutes. Then the mixture is cured at 150 C for 180 minutes. Alternatively, it can be left in the room temperature for 1 day. Finally, the replica is released from the mold and the free-standing PDMS substrate with the embossed surface patterns designed by the laser marking machine is achieved. FIG. 2(b) depicts the PDMS substrates made from the mold that was engraved by various laser fill spacing setting. Moreover, FIG. 3 exemplifies optical microscopic images of the PDMS substrates to have the same patterns as those of the Al mold. It is seen that the micro-sized patterns of the engraved and non-engraved parts (black and white stripes, respectively) of the Al mold also reflect precisely on the PDMS substrates, shown in the second row of the table. Plus, PDMS substrates are shown to have nano-scaled roughness within the micro-sized stripe patterns allowing these substrates to have the capillary effect and to be adsorbable.

### Example III

In a particular exemplary embodiment, an active polymeric SERS substrate is achieved when the surface of the adsorbable PDMS substrate is coated with nanoparticles of noble metal. Silver (Ag) is selected as the noble metal to coat the PDMS substrates. As shown in the literature, Ag is the noble metal that can enhance Raman signal the highest thus far. This high enhancement property of Ag makes distinguishing various Raman spectra more easily.

A 3-inch diameter silver target with 99% purity is utilized. Particularly, a magnetron sputtering system is the chosen type of a physical vapor deposition system (PVD) for Ag deposition. In a particular exemplary embodiment, the vacuum level of 5×10⁻⁶ mBar is created by rotary and turbomolecular pumps prior to deposition. Furthermore, argon (Ar) flow rate of 10 cm³/minute is fed into the chamber right before deposition. During deposition, the chamber pressure is regulated at 3×10³ mBar, the direct current (DC) and power of the sputtering system are 0.1 A and 90 W, respectively. The deposition time is 30 seconds. FIG. 4(b) shows that the resultant Ag-coated-polymeric substrate has the hot spots which are 50-100 nm apart. This matches closely to the result from the study by H. Tang, et al. (H. Tang, G. Meng, Q. Huang, Z. Zhang, Z. Huang and C. Zhu, Adv. Funct. Mater. 22, 218-224 (2012)) which concluded that the distance between clusters of noble metal nanoparticles that yield the highest Raman signal enhancement is 50 nm.

### Example IV

In a particular exemplary embodiment, the performance of the adsorbable polymeric SERS substrate is tested by having 5.0×10⁻² mL of MB with the concentration of 1.0×10⁻⁶ Mol dropped onto the substrate. Then it is undergone a Raman spectroscopy measurement by a confocal Raman spectroscope with the laser wavelength setting of 785 nm. The measurement is performed in 10 seconds. The result is depicted in FIG. 6 where the fill spacing of 0.02 mm results in a spectrum that is more difficult to distinguish. The spectrum from the fill spacing of 0.04-0.14 mm produce a spectrum that has clear and distinctive peaks. The peaks of MB are shown at 446, 501, 763, 1393, and 1621 cm⁻¹. This is due to the following bonds: δ(C—N—C), δ(C—N—C), N/A, α(C—H) ring and ν(C—C) ring respectively, as explained in the studies as follows: R. R. Naujok, R. V. Duevel, R. M. Corn, Langmuir 9, 1771 (1993), N. Felidj, J. Aubard, G. Levi, J. R. Krenn, M. Salerno, G. Schiner, B. Lamprecht, A. Leitner, F. R. Aussenegg, Phys. Rev. B 65, 075419-075427 (2002), and G. N. Xiao, and S. Q. Man, Chem, Phys. Lett. 447, 305 (2007). It is apparent that for the laser fill spacing that is too fine, as fine as 0.02 mm, the entire substrate surface is engraved—losing the black and white patterns (engraved and non-engraved areas) which are crucial for the capillary effect to take place. For the laser fill spacing of 0.04-0.14 mm, the pattern of engraved and non-engraved areas can form. Plus, within the engraved area that is in micron size, there exist nano-sized rough features, which is essential for the capillary effect and the adsorb ability of the polymeric SERS substrate. As shown in FIG. 6 graph(b), being able to detect all five peaks of MB even though the concentration is as low as 1.0×10⁻⁶ Mol means that this invention is a high-performance SERS substrate.

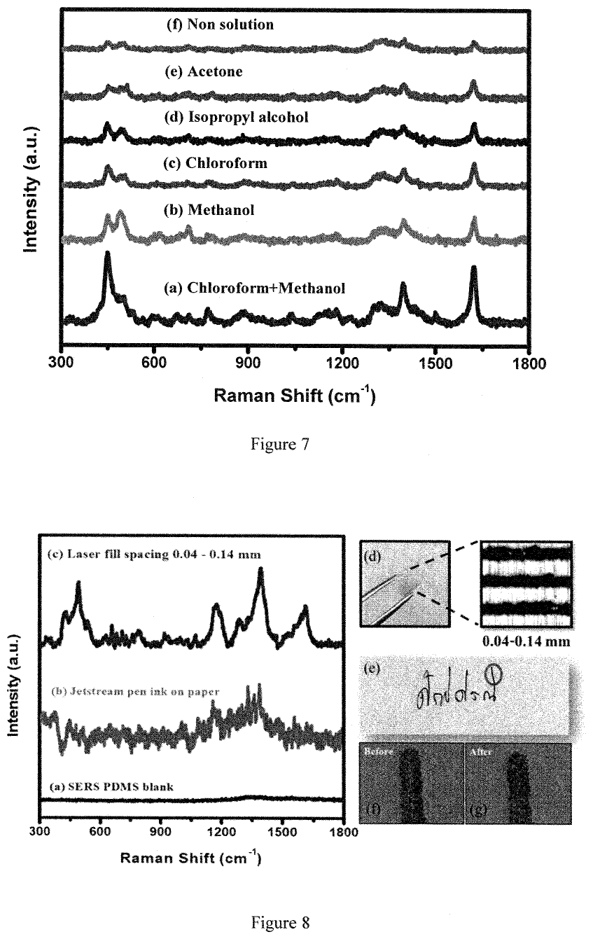

In a further particular embodiment, the capillary effect which is essentially the ability to adsorb particles from the substance in question is tested. MB of concentration 1.0×10⁻⁶ Mol and with the amount of 2 μL is dropped onto a clean glass slide and left to dry in room temperature for 30 minutes. Then the adsorbable polymeric SERS substrate is dipped into a mixture of 1:1 methanol and chloroform. The polymeric SERS substrate is placed on the glass slide that has the dry MB on top for 120 seconds in such a way that the rough surface with coated Ag is placed against the dry MB on the glass slide. Then it is brought into a Raman spectroscope to see the result. FIG. 7 graph(a) depicts the Raman spectrum from this measurement. Four peaks of MB can be easily observed from the spectrum. Hence, this invention of polymeric SERS substrate can adsorb particles from the substance in question. Moreover, the testing procedure of the substance in question does not require any extraction, nor does it require any cutting into the sample of substance. Therefore, the measuring procedure by the adsorbable polymeric substrate is considered non-destructive to the sample of the substance in question.

In a further particular exemplary embodiment, different solutions which assist the polymeric SERS substrate to adsorb particles from the substance in question are explored. FIG. 7 depicts the graphs of the different solutions that are explored. The solutions include methanol, chloroform, isopropyl alcohol, acetone and the mixture of 1:1 chloroform and methanol. It can be seen from the spectrum that all these solutions assist the polymeric SERS to adsorb the testing substance, as MB peaks showed up in all cases. Even for the case when no solution is used at all, the polymeric SERS substrate can still adsorb the particles as the peaks also show up in the spectrum. Although, the solution that assists the polymeric SERS substrate the most is the mixture of 1:1 chloroform and methanol as the peaks are the most distinguishable as seen in FIG. 7.

### Example V

In a particular embodiment, the adsorbable polymeric SERS substrate in this invention is used to perform Raman measurement of pen ink written on a piece of paper. This is to imitate real-world application where Raman spectroscopy can assist in forensic investigation—in this case the document forgery. FIG. 8 graph(a) depicts the Raman spectrum of the polymeric SERS substrate before it is used to do the measurement. FIG. 8 graph(b) is the Raman spectrum of the pen ink written of a piece of paper. The peaks are difficult to read without the enhancement from a SERS substrate. Finally, the adsorbable polymeric SERS substrate (based on the laser fill spacing of 0.04-0.14 mm mold) is dipped into the 1:1 chloroform and methanol solution then its top side with the coated Ag is placed against the piece of paper with pen ink written on. This is illustrated in FIG. 8(e), the circled area is where the SERS substrate is placed against. The physical image of the adsorbable polymeric SERS substrate used is illustrated in FIG. 8(d) where the optical microscopic image shows the existent of the pattern of engraved and non-engrave (black and white) areas. The Raman spectrum when using the adsorbable polymeric SERS substrate on the pen ink is shown in FIG. 8(c). The peaks are clear and distinguishable. The images of the area where the SERS substrate is placed against the piece of paper that has pen ink written on is illustrated in FIG. 8(f) and FIG. 8(g). It is the same circled area as shown in FIG. 8(e). The images indicate that there is no destruction to the piece of paper with the pen ink written on as the before and after images (FIG. 8(f) and FIG. 8(g), respectively) are essentially the same. Therefore, this invention is applicable to real-world cases and can perform non-destructive measurement to the sample.

Even though the present invention is reported with reference to the exemplified embodiments, it should be inferred that the invention is not limited hereto. The described embodiments are to be considered in all respects as illustrative and not restrictive. Additional modifications and embodiments within the scope thereof can be recognized by those having ordinary skill in the art. Appropriately, such modifications and/or embodiments are considered to be included within the scope of the claims.

1. An adsorbable polymeric surface-enhanced Raman spectroscopy (SERS) substrates comprising:
a polymeric base comprising:
embossed structures on the surface; and
noble metal nanoparticles dispersed on the polymeric base,
the embossed structures comprising nanometer-sized features embedded in micrometer-sized stripe patterns,
wherein the polymeric base exhibits a capillary effect by the nanometer-sized features,
the embossed stripe pattern having a ridge with a width ranging from 15-80 μm, wherein the distance between the ridges of the embossed stripe pattern is 0.04-0.14 mm, and the distances between the dispersed noble metal nanoparticles are between 50-200 nm.

2. The adsorbable polymeric SERS substrates according to claim 1 wherein the polymeric base comprises polydimethylsiloxane (PDMS), polymethyl methacrylate (PMMA) or epoxy-based negative photoresist.

3. The adsorbable polymeric SERS substrates according to claim 1, wherein the type of noble metal coated on the polymeric base comprises silver (Ag), gold (Au), platinum (Pt), copper (Cu), palladium (Pd), or combinations thereof.

4. A fabrication process of adsorbable polymeric surface-enhanced Raman spectroscopy (SERS) substrates by using a laser marking machine to create a roughened metal mold for making a flexible replica on which particles of noble metal are coated, the fabrication process comprising:
making a metal mold by a laser marking machine by having nanometer-sized rough features embedded in the micrometer-sized patterns of the engraved and non-engraved areas;
making polymeric replicas by using the fabricated metal mold; and
depositing particles of noble metal onto the flexible replica to yield an active SERS substrate,
wherein the finished products possess the capillary effect allowing for non-destructive Raman measurement of the sample in question and that sufficient numbers of hot spots are present for high Raman signal enhancement which results from making the distance between noble metal nanoparticles between 50-200 nm, and the laser fill spacing setting for engraving the metal mold by a laser marking machine is 0.04-0.14 mm.

5. The fabrication process according to claim 4, wherein the laser marking machine comprises a Nd-YAG laser with a wavelength of 1000-1100 nm.

6. The fabrication process according to claim 4 having a power setting for engraving the metal mold by a laser marking machine ranging from 1-20 W.

7. The fabrication process according to claim 4, wherein the laser engraving is performed by passing the laser over the metal mold 1-50 times.

8. The fabrication process according to claim 4, wherein the marking speed for engraving the metal mold is 1-10,000 mm/s.

9. The fabrication process according to claim 4, wherein the setting of laser frequency for engraving the metal mold is 30-300 kHz.

10. The fabrication process according to claim 4, wherein the laser settings for engraving the metal mold include the power of 10-20 W, fill spacing of 0.04-0.14 mm, ass of 1-10 times, marking speed of 300-700 mm/s, and frequency of 20-50 kHz.

11. The fabrication process according to claim 4, wherein the polymeric replicas comprise PDMS, PMMA or epoxy-based negative photoresist.

12. The fabrication process according to claim 11, wherein the polymer is PDMS.

13. The fabrication process according to claim 12, wherein the PDMS replicas made from the metal mold comprises the steps:
Mixing the polydimethylsiloxane base and curing agent together between 10:1 to 10:5 ratio to form a mixture;
Putting the mixture in a desiccator for 90 minutes to remove air bubbles;
Pouring the mixture into the metal mold and bringing it back into the desiccator for 90 minutes to remove air bubbles;
Curing the mixture; and
Releasing the PDMS replicas from the metal mold.

14. The fabrication process according to claim 4, wherein depositing noble metal particles onto the flexible replicas is performed by a physical vapor deposition (PVD) system.

15. The fabrication process according to claim 14, wherein the PVD system comprises a magnetron sputtering system.

16. The fabrication process according to claim 4, wherein the noble metal to be deposited on the PDMS replicas comprises silver (Ag), gold (Au), platinum (Pt), copper (Cu) or palladium (Pd).

17. The fabrication process according to claim 4, wherein the noble metal for coating the PDMS replicas is silver (Ag).

18. The fabrication process according to claim 4, wherein the particles of noble metal to deposit on the PDMS replicas have a size in the nanometer range.

19. The fabrication process according to claim 17, wherein the depositing step uses a silver sputtering target which has a purity greater than 99% and a diameter of 3 inches.

20. The fabrication process according to claim 15, wherein the vacuum level in a magnetron sputtering system is reached by utilizing a rotary pump and a turbo-molecular pump such that the pre-deposited chamber pressure is 5×10⁶ mbar.

21. The fabrication process according to claim 4, wherein the argon flow rate during the deposition of noble metal nanoparticles onto the PDMS replicas is 5-15 cm³/min

22. The fabrication process according to claim 4, wherein chamber pressure during the deposition of noble metal nanoparticles onto the PDMS replicas is regulated between 9×10³-9×10² mbar.

23. The fabrication process according to claim 4, wherein the DC current and power of the PVD system during the deposition of noble metal nanoparticles onto the PDMS replicas is 0.1-0.5 A and 50-300 W, respectively.

24. The fabrication process according to claim 4, wherein the deposition time of noble metal nanoparticles in the PVD system is 1-400 s.

25. The fabrication process according to claim 12, wherein the configuration during the deposition of noble metal nanoparticles onto the PDMS replicas include argon flow rate of 5-15 cm³/min, chamber pressure of 1×10³-9×10² mbar, DC power of 50-200 W, and time of 1-400 s.

26. The fabrication process according to claim 13, wherein curing is performed at 150° C. for 180 minutes or at room temperature for 24 hours.
